(19) United States
(12) Patent Application Publication
(10) Pub. No.: US 2025/0238266 A1
(43) Pub. Date: Jul. 24, 2025

(54) CONTAINER ORCHESTRATION DEVICE FOR MANAGING AND ALLOCATING CLOUD SERVER RESOURCE

(71) Applicant: Electronics and Telecommunications Research Institute, Daejeon (KR)

(72) Inventors: Siwoon SON, Daejeon (KR); Jiwoo HAN, Daejeon (KR)

(73) Assignee: Electronics and Telecommunications Research Institute, Daejeon (KR)

(21) Appl. No.: 19/013,090

(22) Filed: Jan. 8, 2025

(30) Foreign Application Priority Data
Jan. 18, 2024 (KR) 10-2024-0008000
Jul. 29, 2024 (KR) 10-2024-0099963

(51) Int. Cl. G06F 9/50

(52) U.S. Cl. CPC G06F 9/5027

(57) ABSTRACT

Disclosed is a container orchestration device. The container orchestration device includes a cloud management unit, a cluster management unit, and a namespace management unit. The cloud management unit communicates with a cloud server based on user request signals. The cluster management unit generates a container orchestration tool within the cloud server based on a first request signal among the user request signals and allocates the container orchestration tool to a first user group. The namespace management unit generates one or more namespace instances within the container orchestration tool based on the first request signal and allocates the one or more namespace instances to each user of the first user group.

### CROSS-REFERENCE TO RELATED APPLICATIONS

This application claims priority under 35 U.S.C. § 119 to Korean Patent Application No. 10-2024-0008000 filed on Jan. 18, 2024 and Korean Patent Application No. 10-2024-0099963 filed on Jul. 29, 2024, in the Korean Intellectual Property Office, the disclosures of which are incorporated by reference herein in their entireties.

### BACKGROUND

Embodiments of the present disclosure described herein relate to a container orchestration device, and more particularly, relate to a container orchestration device for managing and allocating cloud server resources.

Cloud computing is a service that provides servers, storage, or databases by virtualizing computing resources (e.g., CPU, memory, disk, network, and the like) in an on-demand manner, and as a unit of providing such services, containers may virtualize computing resources within a cloud server at an operating system level and execute processes, such as applications, in an isolated environment.

A user group (or users of a user group) that desires to use containers may deploy specific containers within a cloud server to execute desired applications. The number of containers deployed by different users or user groups may increase. To efficiently manage limited computing resources and increasing containers within a cloud server, it is necessary to efficiently distribute or allocate computing resources to users or user groups.

### SUMMARY

Embodiments of the present disclosure provide a container orchestration device that generates container orchestration tools and namespace instances within a cloud server and allocates them to user groups and users.

According to an embodiment, a container orchestration device includes a cloud management unit, a cluster management unit, and a namespace management unit. The cloud management unit communicates with a cloud server based on user request signals. The cluster management unit generates a container orchestration tool within the cloud server based on a first request signal among the user request signals and allocates the container orchestration tool to a first user group. The namespace management unit generates one or more namespace instances within the container orchestration tool based on the first request signal and allocates the one or more namespace instances to each user of the first user group.

According to an embodiment, the container orchestration device further includes a storage unit. The storage unit stores a plurality of cluster template information, each of which includes system resources of a plurality of flavors. The cluster management unit generates the plurality of cluster template information based on the first request signal, stores the plurality of cluster template information in the storage unit, and generates the plurality of flavors on the cloud server.

According to an embodiment, the cluster management unit generates cluster instance information based on the first request signal and the plurality of cluster template information, and stores the cluster instance information in the storage unit.

According to an embodiment, the cluster management unit generates a plurality of virtual machine instances in the cloud server based on the cluster instance information, and sets up the container orchestration tool based on the plurality of virtual machine instances.

According to an embodiment, the cluster management unit periodically monitors the plurality of virtual machine instances constituting the container orchestration tool based on the cluster instance information, and updates the storage unit based on a result of monitoring the plurality of virtual machine instances.

According to an embodiment, the cluster management unit deletes the cluster instance information from the storage unit based on the first request signal.

According to an embodiment, the storage unit further stores a plurality of namespace template information, each of the plurality of namespace template information including namespace storage resources. The namespace management unit generates the plurality of namespace template information based on the first request signal and stores the plurality of namespace template information in the storage unit.

According to an embodiment, the namespace management unit generates namespace instance information based on the first request signal and the plurality of namespace template information, and stores the namespace instance information in the storage unit.

According to an embodiment, the namespace management unit updates the container orchestration tool based on the namespace instance information.

According to an embodiment, the namespace management unit periodically monitors the one or more namespace instances included in the container orchestration tool based on the namespace instance information, and updates the storage unit based on a result of monitoring the one or more namespace instances.

According to an embodiment, the namespace management unit deletes the namespace instance information from the storage unit based on the first request signal.

According to an embodiment, the first user group includes a plurality of first users. The namespace management unit individually allocates all or some of the one or more namespace instances to each of the plurality of first users.

According to an embodiment, a container orchestration device includes a cloud management unit, a cluster management unit, and a namespace management unit. The cloud management unit communicates with a cloud server based on user request signals. The cluster management unit generates a first container orchestration tool within the cloud server based on a first request signal among the user request signals, allocates the first container orchestration tool to a first user group, generates a second container orchestration tool within the cloud server based on a second request signal among the user request signals, and allocates the second container orchestration tool to a second user group. The namespace management unit generates one or more first namespace instances within the first container orchestration tool based on the first request signal, allocates the one or more first namespace instances to each user of the first user group, generates one or more second namespace instances within the second container orchestration tool based on the second request signal, and allocates the one or more second namespace instances to each user of the second user group.

According to an embodiment, the container orchestration device further includes a storage unit. The storage unit stores a plurality of cluster template information, each of which includes system resources of a plurality of flavors. The cluster management unit generates a plurality of first cluster template information based on the first request signal, stores the plurality of first cluster template information in the storage unit, generates a plurality of second cluster template information based on the second request signal and stores the plurality of second cluster template information in the storage unit, and generates the plurality of flavors on the cloud server.

According to an embodiment, the cluster management unit generates first cluster instance information based on the first request signal and the plurality of first cluster template information, generates second cluster instance information based on the second request signal and the plurality of second cluster template information, and stores the first cluster instance information and the second cluster instance information in the storage unit.

According to an embodiment, the cluster management unit generates a plurality of first virtual machine instances in the cloud server based on the first cluster instance information, sets up the first container orchestration tool based on the plurality of first virtual machine instances, generates a plurality of second virtual machine instances in the cloud server based on the second cluster instance information, and sets up the second container orchestration tool based on the plurality of second virtual machine instances.

According to an embodiment, the storage unit further stores a plurality of namespace template information, each of which includes namespace storage resources. The namespace management unit generates a plurality of first namespace template information based on the first request signal, stores the plurality of first namespace template information in the storage unit, generates a plurality of second namespace template information based on the second request signal, and stores the plurality of second namespace template information in the storage unit.

According to an embodiment, the namespace management unit generates first namespace instance information based on the first request signal and the plurality of first namespace template information, generates second namespace instance information based on the second request signal and the plurality of second namespace template information, and stores the first namespace instance information and the second namespace instance information in the storage unit.

According to an embodiment, the namespace management unit updates the first container orchestration tool based on the first namespace instance information, and updates the second container orchestration tool based on the second namespace instance information.

According to an embodiment, the first user group includes a plurality of first users. The second user group includes a plurality of second users. The namespace management unit individually allocates all or some of the one or more first namespace instances to each of the plurality of first users, and individually allocates all or some of the one or more second namespace instances to each of the plurality of second users.

According to an embodiment, the cluster management unit periodically monitors the first virtual machine instances constituting the first container orchestration tool based on the first cluster instance information, periodically monitors the second virtual machine instances constituting the second container orchestration tool based on the second cluster instance information, and updates the storage unit based on results of monitoring the first virtual machine instances and the second virtual machine instances.

According to an embodiment, the cluster management unit deletes the first cluster instance information from the storage unit based on the first request signal, and deletes the second cluster instance information from the storage unit based on the second request signal.

According to an embodiment, the namespace management unit periodically monitors the one or more first namespace instances included in the first container orchestration tool based on the first namespace instance information, periodically monitors the one or more second namespace instances included in the second container orchestration tool based on the second namespace instance information, and updates the storage unit based on results of monitoring the one or more first namespace instances and the one or more second namespace instances.

According to an embodiment, the namespace management unit deletes the first namespace instance information from the storage unit based on the first request signal, and deletes the second namespace instance information from the storage unit based on the second request signal.

A container orchestration device according to embodiments of the present disclosure may generate a container orchestration tool within a cloud server based on a user request signal and may allocate the container orchestration tool to a user group. The container orchestration device may generate one or more namespace instances within the container orchestration tool and may individually allocate the one or more namespace instances to each user of a user group. According to the container orchestration device, a user group using cloud computing may efficiently manage virtualized computing resources within the cloud, and the user group (or each user of the user group) may freely run and deploy containers by using the allocated orchestration tool and allocated namespace instances

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an example of a container orchestration device according to an embodiment of the present disclosure.

FIG. 2 is a block diagram illustrating another example of the container orchestration device of FIG. 1.

FIG. 3 is a diagram illustrating an example of cluster template information.

FIG. 4 is a diagram illustrating an example of cluster instance information.

FIG. 5 is a block diagram illustrating an example of a cloud server.

FIG. 6 is a diagram illustrating an example of namespace template information.

FIG. 7 is a diagram illustrating an example of namespace instance information.

FIG. 8 is a block diagram illustrating an example of an operation of generating a namespace instance.

FIG. 9 is a diagram illustrating an example of an operation of monitoring cluster instance information.

FIG. 10 is a diagram illustrating an example of an operation of monitoring namespace instance information.

FIG. 11 is a diagram illustrating an example of the relationship between container orchestration tools, user groups, and users of a user group.

FIG. 12 is a diagram illustrating an example of an operation of individually allocating all or some of one or more namespace instances to each user of a user group.

FIG. 13 is a diagram illustrating examples of the user request signals of FIG. 1.

FIG. 14 is a block diagram illustrating still another example of the container orchestration device of FIG. 1.

### DETAILED DESCRIPTION

Hereinafter, embodiments of the present disclosure will be described clearly and in detail so that those skilled in the art can easily carry out embodiments of the present disclosure.

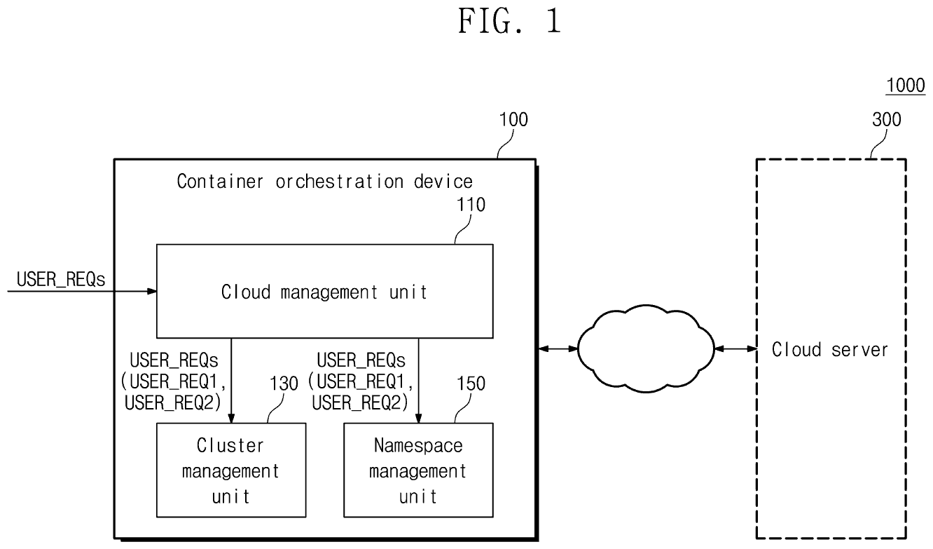

FIG. 1 is a block diagram illustrating an example of a container orchestration device according to an embodiment of the present disclosure.

Referring to FIG. 1, a container orchestration system 1000 may include a container orchestration device 100 and a cloud server 300. For example, the container orchestration system 1000 may include a system that virtualizes computing resources in the cloud server 300 and allocates the computing resources to user groups (or users of user groups).

In an embodiment, the container orchestration system 1000 may virtualize computing resources to run an operating system, and user groups may utilize the virtualized computing resources. For example, the container orchestration device 100 may request computing resources from the cloud server 300, and the cloud server 300 may provide the requested computing resources to user groups. For example, the virtualized computing resources may include a plurality of virtual machine instances.

The container orchestration device 100 may include a cloud management unit 110, a cluster management unit 130, and a namespace management unit 150.

The cloud management unit 110 may communicate with the cloud server 300 based on user request signals USER_REQs. For example, the user request signals USER_REQs may be input by user groups which desire to utilize the computing resources of the cloud server 300. For example, the user request signals USER_REQs may include a first request signal USER_REQ1 and a second request signal USER_REQ2. The first request signal USER_REQ1 may be input by users belonging to a first user group, and the second request signal USER_REQ2 may be input by users belonging to a second user group. The user request signals USER_REQs will be described later with reference to FIG. 13.

In an embodiment, the cloud management unit 110 may communicate with the cloud server 300 and periodically check the communication status with the cloud server. The cloud server 300 may generate, manage, or delete a plurality of virtual machine instances.

In an embodiment, the cloud management unit 110 may transmit the user request signals USER_REQs to the cluster management unit 130 and the namespace management unit 150.

The cluster management unit 130 may generate container orchestration tools within the cloud server 300 based on the user request signals USER_REQs and allocate the container orchestration tools to user groups. For example, the cluster management unit 130 may generate a first container orchestration tool based on the first request signal USER_REQ1 and allocate the first container orchestration tool to the first user group. For example, the cluster management unit 130 may generate a second container orchestration tool based on the second request signal USER_REQ2 and allocate the second container orchestration tool to the second user group.

The namespace management unit 150 may generate one or more namespace instances within the container orchestration tools based on the user request signals USER_REQs and allocate the one or more namespace instances to each user of the user group. For example, the namespace management unit 150 may generate one or more first namespace instances based on the first request signal USER_REQ1 and allocate the one or more first namespace instances to each user of the first user group. For example, the namespace management unit 150 may generate one or more second namespace instances based on the second request signal USER_REQ2 and allocate the one or more second namespace instances to each user of the second user group. The namespace instances may be storage spaces where each user of a user group may run or deploy containers. The container may be the smallest unit for running an application.

Through the configuration described above, the container orchestration device according to embodiments of the present disclosure may generate a container orchestration tool within a cloud server based on a user request signal and allocate the container orchestration tool to a user group. The container orchestration device may generate one or more namespace instances within a container orchestration tool and individually allocate the one or more namespace instances to each user in the user group. By the container orchestration device, a user group using cloud computing may efficiently manage virtualized computing resources within the cloud, and the user group (or each user of the user group) may freely run and deploy containers by using the allocated orchestration tool and allocated namespace instances.

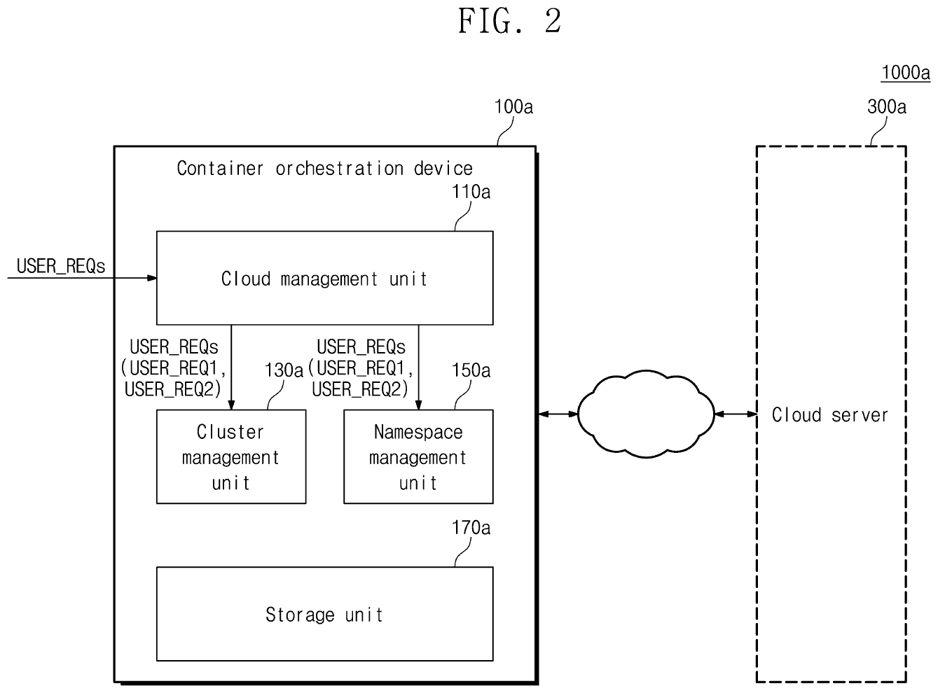

FIG. 2 is a block diagram illustrating another example of the container orchestration device of FIG. 1.

Referring to FIG. 2, a container orchestration system 1000a may correspond to the container orchestration system 1000 of FIG. 1, a container orchestration device 100a may correspond to the container orchestration device 100 of FIG. 1, and a cloud server 300a may correspond to the cloud server 300 of FIG. 1. Comparing with the embodiment illustrated in FIG. 1, redundant descriptions will be omitted.

In an embodiment, the container orchestration device 100a may further include a storage unit 170a.

The storage unit 170a may store information generated in the container orchestration system 1000a. For example, the storage unit 170a may store information generated from a cloud management unit 110a, a cluster management unit 130a, and a namespace management unit 150a.

In an embodiment, the information generated by the cloud management unit 110a may include communication status with the cloud, cloud server access API, cloud server authentication account, virtual machine OS image name, SSH information, and the like.

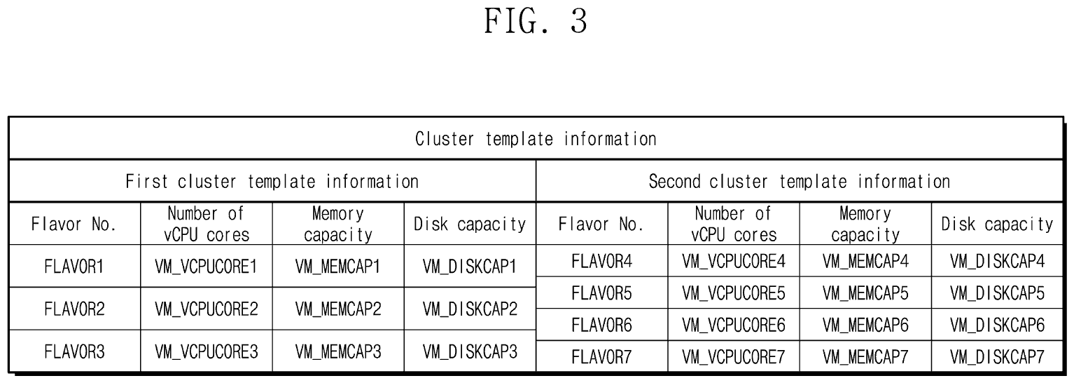

In an embodiment, the information generated by the cluster management unit 130a may include cluster template information, cluster instance information, and the like, and the information generated by the namespace management unit 150a may include namespace template information, namespace instance information, and the like. The information generated by the cluster management unit 130a and the information generated by the namespace management unit 150a will be described later with reference to FIGS. 3, 4, 6 and 7.

FIG. 3 is a diagram illustrating an example of cluster template information.

Referring to FIG. 3, cluster template information may include information about system resources of flavors.

In an embodiment, a cluster management unit (e.g., 130 in FIG. 1 or 130a in FIG. 2) may generate a plurality of cluster template information and store the plurality of cluster template information in a storage unit (e.g., 170a of FIG. 2). For example, the plurality of cluster template information may include information about system resources of a plurality of flavors required by a user group. For example, the information about the system resources of the plurality of flavors may include information about system resources required to generate a plurality of virtual machine instances on a cloud server.

In an embodiment, the cluster management unit may generate the plurality of cluster template information based on the first request signal requested by the first user group. For example, the first request signal may include a signal requesting generation of cluster template information for system resources of the plurality of flavors by the first user group.

In an embodiment, the first cluster template information may include information about system resources of first to third flavors FLAVOR1 to FLAVOR3, and the second cluster template information may include information about system resources of fourth to seventh flavors FLAVOR4 to FLAVOR7, but this is just an example.

In an embodiment, the information about the system resources of the flavors may include the number of virtual CPU cores, the memory capacity of the flavors, the disk capacity of the flavors, or the like. For example, the first cluster template information may include system resources VM_VCPUCORE1, VM_MEMCAP1 and VM_DISKCAP1 of the first flavor FLAVOR1, system resources VM_VCPUCORE2, VM_MEMCAP2 and VM_DISKCAP2 of the second flavor FLAVOR2, and system resources VM_VCPUCORE3, VM_MEMCAP3 and VM_DISKCAP3 of the third flavor FLAVOR3. In addition, the second cluster template information may include system resources VM_VCPUCORE4, VM_MEMCAP4 and VM_DISKCAP4 of the fourth flavor FLAVOR4, system resources VM_VCPUCORE5, VM_MEMCAP5 and VM_DISKCAP5 of the fifth flavor FLAVOR5, system resources VM_VCPUCORE6, VM_MEMCAP6 and VM_DISKCAP6 of the sixth flavor FLAVOR6, and system resources VM_VCPUCORE7, VM_MEMCAP7 and VM_DISKCAP7 of the seventh flavor FLAVOR7.

In an embodiment, the cluster management unit may generate a plurality of flavors in a cloud server (e.g., 300 in FIG. 1, 300a in FIG. 2) based on a plurality of cluster template information, and may generate a plurality of virtual machine instances based on the plurality of flavors. The operation of generating the plurality of virtual machine instances will be described later with reference to FIG. 5.

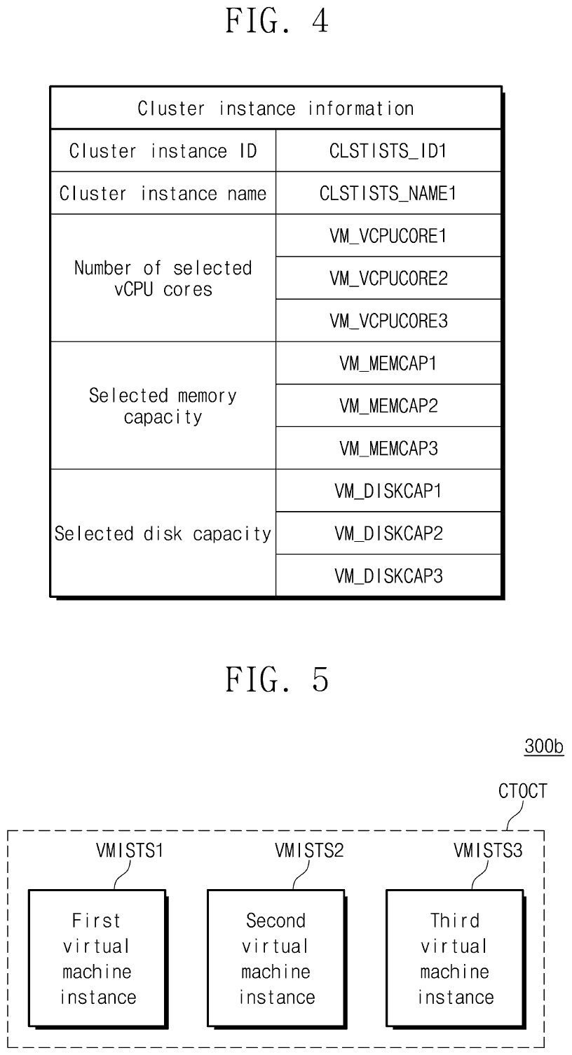

FIG. 4 is a diagram illustrating an example of cluster instance information.

FIG. 4 illustrates cluster instance information.

In an embodiment, a cluster management unit (e.g., 130 in FIG. 1, 130a in FIG. 2) may generate the cluster instance information based on the first request signal and the plurality of cluster template information, and store the cluster instance information in a storage unit (e.g., 170a in FIG. 2). For example, the cluster management unit may select the first cluster template information from the plurality of cluster template information illustrated in FIG. 3 to generate the cluster instance information. Referring to FIG. 4, the cluster instance information including the first cluster template information illustrated in FIG. 3 is illustrated, but this is just an example. For example, a user group may request the second cluster template information among the plurality of cluster template information illustrated in FIG. 3, and the cluster management unit may select the second cluster template information to generate the cluster instance information.

FIG. 5 is a block diagram illustrating an example of a cloud server.

In an embodiment, a cluster management unit (e.g., 130 in FIG. 1 or 130a in FIG. 2) may generate a plurality of virtual machine instances in a cloud server 300b based on cluster instance information. For example, the cluster management unit may request the cloud server 300b to generate the plurality of virtual machine instances based on the cluster instance information, and the cloud server 300b may generate the plurality of virtual machine instances. For example, the cloud server 300b may generate a plurality of flavors within the cloud server based on cluster template information, and may generate the plurality of virtual machine instances based on the plurality of flavors.

In an embodiment, the cluster instance information may be information generated by selecting first cluster template information from among the cluster template information of FIG. 3, and the first cluster template information may include information about system resources of the first to third flavors FLAVOR1 to FLAVOR3. For example, the cluster management unit may generate the first to third virtual machine instances VMISTS1, VMISTI2 and VMISTS3 within the cloud server 300b based on the cluster instance information. For example, the first virtual machine instance VMISTST1 may be a virtual machine instance generated within a cloud server based on the system resources VM_CPUCORE1, VM_MEMCAP1 and VM_DISKCAP1 of the selected first flavor FLAVOR1. The second and third virtual machine instances VMISTST2 and VMISTST3 may be virtual machine instances generated within the cloud server based on the system resources VM_CPUCORE2, VM_MEMCAP2 and VM_DISKCAP2 of the selected second flavor FLAVOR2 and the system resources VM_CPUCORE3, VM_MEMCAP3 and VM_DISKCAP3 of the selected third flavor FLAVOR3, respectively.

In an embodiment, the cluster management unit may set up a container orchestration tool CTOCT based on the plurality of virtual machine instances VMISTS1 to VMISTS3. For example, the cluster management unit may set up the container orchestration tool CTOCT by connecting the first to third virtual machine instances VMISTS1 to VMISTS3. Referring to FIG. 5, the container orchestration tool CTOCT is set up by connecting the first to third virtual machine instances VMISTS1 to VMISTS3, but this is only an example.

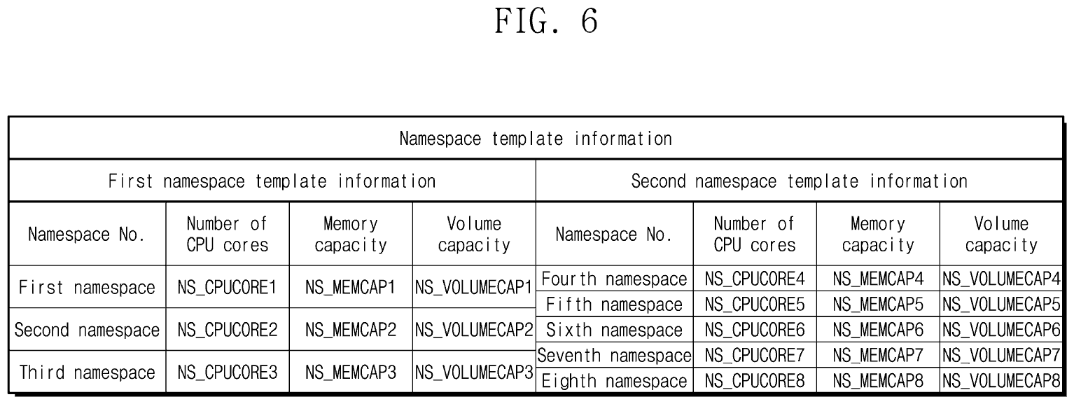

In an embodiment, the cluster management unit may allocate the container orchestration tool CTOCT to a first user group. For example, the first user group may generate and use one or more namespace instances within the allocated container orchestration tool. The operation of generating one or more namespace instances will be described below with reference to FIGS. 6 to 8.

FIG. 6 is a diagram illustrating an example of namespace template information.

Referring to FIG. 6, namespace template information may include information about storage resources of namespaces.

In an embodiment, a namespace management unit (e.g., 150 in FIG. 1 or 150a in FIG. 2) may generate namespace template information and store the namespace template information in a storage unit (e.g., 170a in FIG. 2). For example, the plurality of namespace template information may include information about the number of namespaces required by a user group and storage resources of the namespaces. For example, the information about the storage resources of the namespaces may include information for generating one or more namespace instances within a container orchestration tool.

In an embodiment, the namespace management unit may generate the plurality of namespace template information based on a first request signal requested by a first user group. For example, the first request signal may be a signal for requesting the generation of namespace template information for storage resources of one or more namespace instances that the first user group desires to generate within the container orchestration tool.

In an embodiment, the first namespace template information may include information about storage resources of first to third namespaces NS1 to NS3, and the second namespace template information may include information about storage resources of fourth to eighth namespaces NS4 to NS8, but this is just an example. The first through eighth namespaces NS1 to NS8 are distinct from the one or more namespace instances generated within the container orchestration tool.

In an embodiment, the storage resources of the namespaces may include the number of CPU cores, the memory capacity of the namespace instances to be generated, the volume capacity of the namespace instances to be generated, and the like. For example, the first namespace template information may include storage resources NS_CPUCORE1, NS_MEMCAP1 and NS_VOLUMECAP1 of the first namespace NS1, storage resources NS_CPUCORE2, NS_MEMCAP2 and NS_VOLUMECAP2 of the second namespace NS2, and storage resources NS_CPUCORE3, NS_MEMCAP3 and NS_VOLUMECAP3 of the third namespace NS3. In addition, the second namespace template information may include storage resources NS_CPUCORE4, NS_MEMCAP4 and NS_VOLUMECAP4 of the fourth namespace NS4, storage resources NS_CPUCORE5, NS_MEMCAP5 and NS_VOLUMECAP5 of the fifth namespace NS5, storage resources NS_CPUCORE6, NS_MEMCAP6 and NS_VOLUMECAP6 of the sixth namespace NS6, storage resources NS_CPUCORE7, NS_MEMCAP7 and NS_VOLUMECAP7 of the seventh namespace NS7, and storage resources NS_CPUCORE8, NS_MEMCAP8 and NS_VOLUMECAP8 of the eighth namespace NS8.

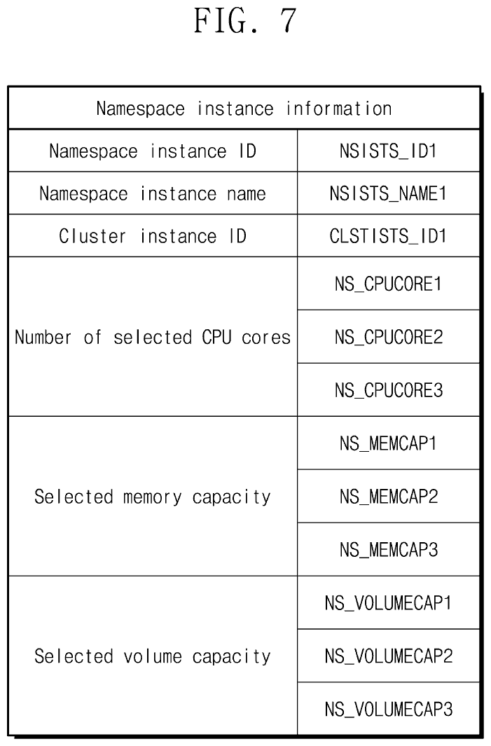

FIG. 7 is a diagram illustrating an example of namespace instance information.

FIG. 7 illustrates namespace instance information.

In an embodiment, a namespace management unit (e.g., 150 in FIG. 1, 150a in FIG. 2) may generate namespace instance information based on a first request signal and a plurality of namespace template information, and may store the namespace instance information in a storage unit (e.g., 170a in FIG. 2). For example, the namespace management unit may select first namespace template information from among the plurality of namespace template information illustrated in FIG. 6 to generate the namespace instance information. Referring to FIG. 7, the namespace instance information including the first namespace template information illustrated in FIG. 6 is illustrated, but this is just an example. For example, a user group may request second namespace template information among the plurality of namespace template information illustrated in FIG. 6, and the namespace management unit may select the second namespace template information to generate the namespace instance information.

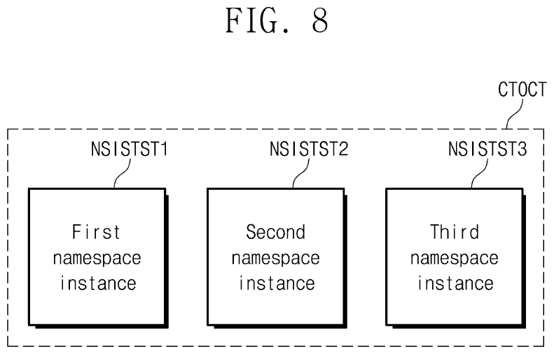

FIG. 8 is a block diagram illustrating an example of an operation of generating a namespace instance.

Referring to FIG. 8, a container orchestration tool and namespace instances are illustrated.

In an embodiment, a namespace management unit (e.g., 150 in FIG. 1 or 150a in FIG. 2) may update the container orchestration tool CTOCT based on namespace instance information. Updating a container orchestration tool may mean generating one or more namespace instances based on the namespace instance information within the container orchestration tool.

In an embodiment, the namespace instance information may be information generated by selecting the first namespace template information from among the namespace template information of FIG. 6, and the first namespace template information may include information about storage resources of the first to third namespaces NS1 to NS3.

In an embodiment, the namespace management unit may generate first to third namespace instances NSISTST1, NSISTST2 and NSISTST3 within the container orchestration tool based on the namespace instance information. For example, the first namespace instance NSISTS1 may be a namespace instance generated within the container orchestration tool based on the selected first namespace storage resources NS_CPUCORE1, NS_MEMCAP1 and NS_VOLUMECAP1. The second and third namespace instances NSISTST2 and NSISTST3 may be namespace instances generated within the container orchestration tool based on the selected second namespace storage resources NS_CPUCORE2, NS_MEMCAP2 and NS_VOLUMECAP3 and the selected third namespace storage resources NS_CPUCORE3, NS_MEMCAP3 and NS_VOLUMECAP3), respectively.

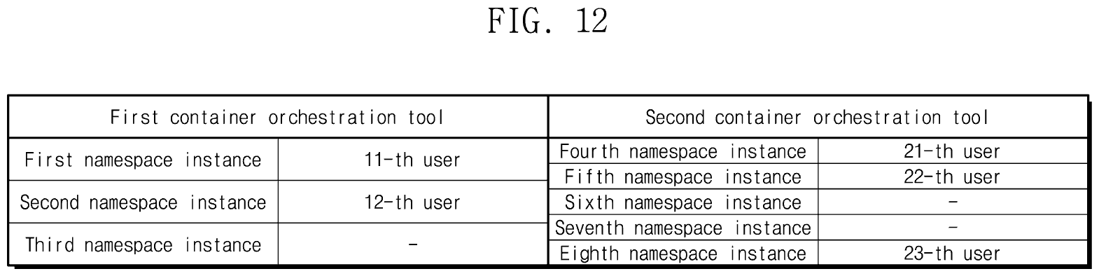

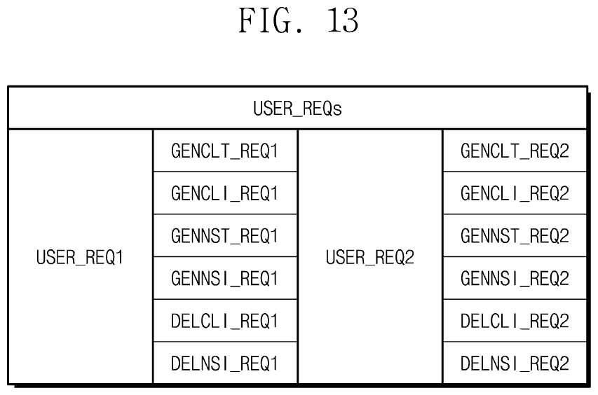

In an embodiment, the namespace management unit may allocate the first to third namespace instances NSISTS1 to NSISTS3 to each user of the first user group. For example, each user of the first user group may freely run or deploy a container for running an application based on the allocated namespace instance. The operation of allocating one or more namespaces will be described below with reference to FIG. 12.

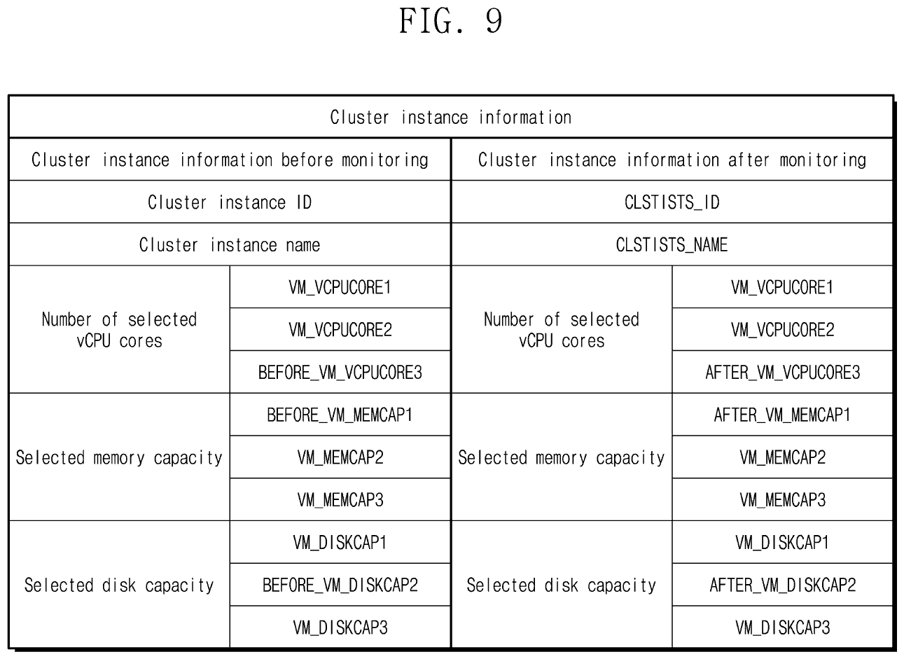

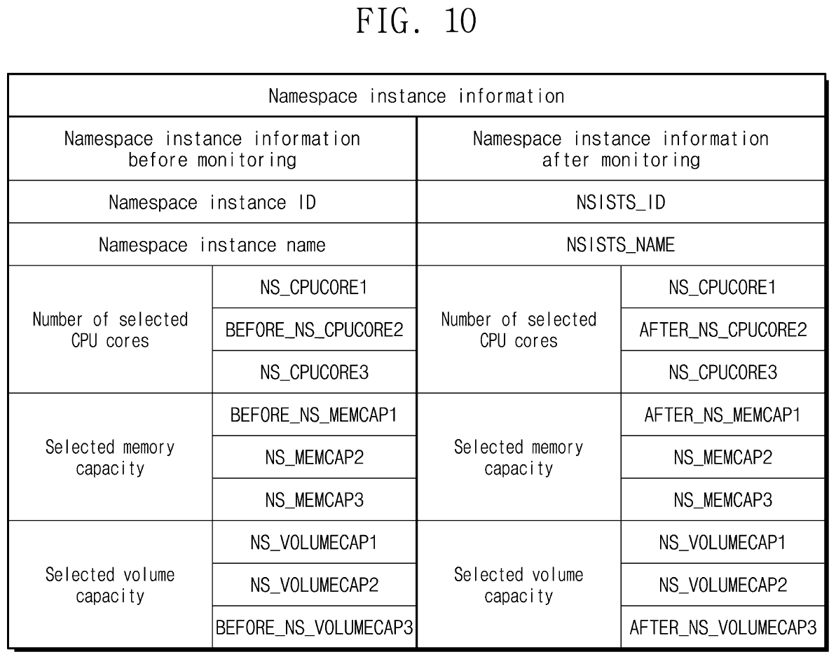

FIG. 9 is a diagram illustrating an example of an operation of monitoring cluster instance information.

FIG. 9 illustrates cluster instance information before monitoring and cluster instance information after monitoring.

Referring to FIG. 9, a cluster management unit (e.g., 130 in FIG. 1 or 130a in FIG. 2) may periodically monitor a plurality of virtual machine instances based on cluster instance information. For example, the cluster management unit may periodically monitor system resources of the plurality of virtual machine instances that constitute a container orchestration tool. For example, the cluster management unit may periodically monitor whether the number of vCPU cores, memory capacity, or disk capacity of the plurality of virtual machine instances that constitute the container orchestration tool change.

In an embodiment, the cluster management unit may update a storage unit (e.g., 170a in FIG. 2) based on a result of monitoring the plurality of virtual machine instances. For example, the cluster management unit may monitor a change in memory capacity of a first virtual machine instance (e.g., change from BEFORE_VM_MEMCAP1 to AFTER_VM_MEMCAP1), a change in disk capacity of a second virtual machine instance (e.g., change from BEFORE_VM_DISKCAP2 to AFTER_VM_DISKCAP2), and a change in the number of vCPU cores of a third virtual machine (e.g., change from BEFORE_VM_VCPUCORE3 to AFTER_VM_VCPUCORE3), and may update the storage unit based on the cluster instance information after monitoring.

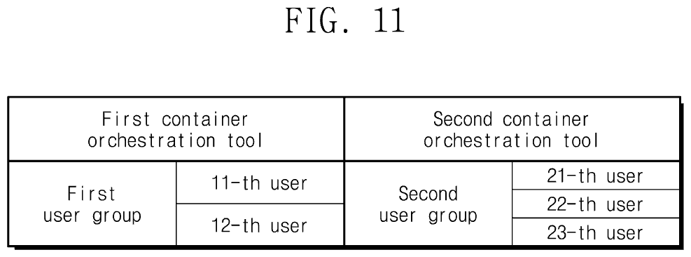

FIG. 10 is a diagram illustrating an example of an operation of monitoring namespace instance information.

FIG. 10 illustrates namespace instance information before monitoring and namespace instance information after monitoring.

Referring to FIG. 10, a namespace management unit (e.g., 150 in FIG. 1 or 150a in FIG. 2) may periodically monitor one or more namespace instances based on namespace instance information. For example, the namespace management unit may periodically monitor storage resources of one or more namespace instances included in a container orchestration tool. For example, the namespace management unit may periodically monitor whether the number of CPU cores, memory capacity, or volume capacity of one or more namespace instances included in the container orchestration tool changes.

In an embodiment, the namespace management unit may update a storage unit (e.g., 170a in FIG. 2) based on a result of monitoring one or more namespace instances. For example, the namespace management unit may monitor a change in the memory capacity of a first namespace instance (e.g., change from BEFORE_NS_MEMCAP1 to AFTER_NS_MEMCAP1), a change in the number of CPUs of a second namespace instance (e.g., change from BEFORE_NS_CPUCORE1 to AFTER_NS_CPUCORE1), and a change in the volume capacity of a third namespace instance (e.g., change from BEFORE_NS_VOLUMECAP3 to AFTER_NS_VOLUMECAP3), and may update a storage unit based on the namespace instance information after the monitoring.

FIG. 11 is a diagram illustrating an example of the relationship between container orchestration tools, user groups, and users of a user group.

FIG. 11 illustrates container orchestration tools, user groups, and users.

Referring to FIG. 11, a cluster management unit (e.g., 130 in FIG. 1 or 130a in FIG. 2) may generate container orchestration tools based on user request signals and allocate the container orchestration tools to user groups. For example, the user groups may include a first user group and a second user group, and the user request signals may include a first request signal and a second request signal. In an embodiment, the cluster management unit may generate a first container orchestration tool based on the first request signal requested by the first user group, and allocate the first container orchestration tool to the first user group. In an embodiment, the cluster management unit may generate a second container orchestration tool based on the second request signal requested by the second user group, and allocate the second container orchestration tool to the second user group.

In an embodiment, the first user group may include a plurality of first users (e.g., the 11-th user and the 12-th user), and the second user group may include a plurality of second users (e.g., the 21-th user, the 22-th user and the 23-th user). The plurality of first users may use the first container orchestration tool, and the plurality of second users may use the second container orchestration tool.

FIG. 12 is a diagram illustrating an example of an operation of individually allocating all or some of one or more namespace instances to each user of a user group.

FIG. 12 illustrates container orchestration tools, namespace instances, and users of a user group.

Referring to FIG. 12, a namespace management unit (e.g., 150 in FIG. 1 or 150a in FIG. 2) may generate one or more namespace instances based on user request signals, and individually allocate the one or more namespace instances to each user of a user group.

For example, the namespace management unit may individually allocate one or more namespace instances included in a first container orchestration tool to each of the first users (e.g., an 11-th user and a 12-th user) of a first user group. For example, the namespace management unit may allocate a first namespace instance to the 11-th user, and may allocate a second namespace instance to the 12-th user. A third namespace instance may not be allocated.

For example, the namespace management unit may individually allocate one or more namespace instances included in the second container orchestration tool to each of the second users (e.g., the 21-th user, the 22-th user and the 23-th user) of the second user group. For example, the namespace management unit may allocate a fourth namespace instance to the 21-th user, a fifth namespace instance to the 22-th user, and an eighth namespace instance to the 23-th user. A sixth namespace instance and a seventh namespace instance may not be allocated.

FIG. 13 is a diagram illustrating examples of the user request signals of FIG. 1.

FIG. 13 illustrates user request signals USER_REQs.

Referring to FIG. 13, the user request signals USER_REQs may include the first request signal USER_REQ1 and the second request signal USER_REQ2. For example, the first request signal USER_REQ1 and the second request signal USER_REQ2 may be the first request signal or the second request signal described above with reference to FIG. 1.

In an embodiment, the user request signals USER_REQs may include cluster template generation signals GENCLT_REQ1 and GENCL_REQ2. For example, the cluster template generation signals may be signals for requesting the generation of a plurality of cluster templates that includes information about system resources of a plurality of flavors required by a user group.

In an embodiment, the user request signals USER_REQs may include cluster instance generation signals GENCLI_REQ1 and GENCLI_REQ2. For example, the cluster instance generation signals may be signals for selecting one cluster template from among a plurality of cluster templates and generating cluster instance information based on the selected cluster template.

In an embodiment, the user request signals USER_REQs may include namespace template generation signals GENNST_REQ1 and GENNST_REQ2. For example, the namespace template generation signals may be signals for requesting the generation of a plurality of namespace templates that include information about storage resources of one or more namespace instances within a container orchestration tool which may be allocated to each user in a user group.

In an embodiment, the user request signals USER_REQs may include namespace instance generation signals GENNSI_REQ1 and GENNSI_REQ2. For example, the namespace instance generation signals may be signals for selecting one namespace template from among a plurality of namespace templates and generating namespace instance information based on the selected namespace template.

In an embodiment, the user request signals USER_REQs may include cluster instance deletion signals DELCLI_REQ1 and DELCLI_REQ2 and namespace instance deletion signals DELNSI_REQ1 and DELNSI_REQ2. For example, the cluster instance deletion signals DELCLI_REQ1 and DELCLI_REQ2 may be signals for deleting cluster instance information from a storage unit, and the namespace instance deletion signals DELNSI_REQ1 and DELNSI_REQ2 may be signals for deleting namespace instance information from the storage unit.

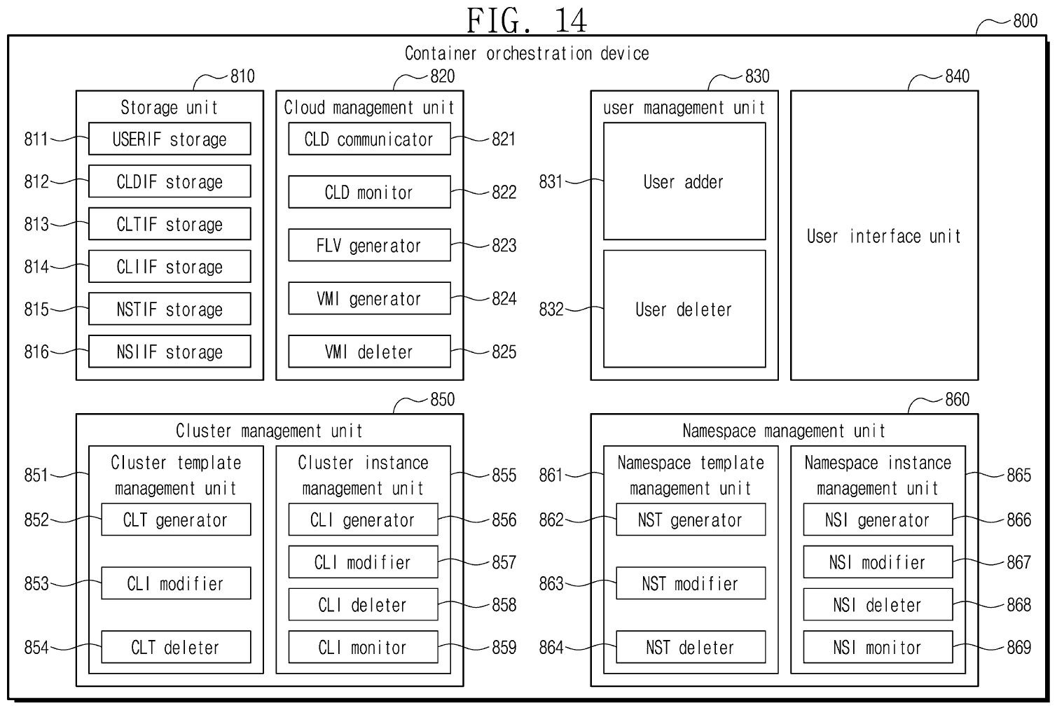

FIG. 14 is a block diagram illustrating still another example of the container orchestration device of FIG. 1.

FIG. 14 illustrates a container orchestration device 800. The container orchestration device may correspond to the container orchestration device 100 in FIG. 1 and the container orchestration device 100a in FIG. 2.

Referring to FIG. 14, the container orchestration device 800 may include a storage unit 810, a cloud management unit 820, a user management unit 830, a user interface unit 840, a cluster management unit 850, and a namespace management unit 860. The storage unit 810 may correspond to the storage unit 170a in FIG. 2. The cloud management unit 820 may correspond to the cloud management unit 110 in FIG. 1 and the cloud management unit 110a in FIG. 2. The cluster management unit 850 may correspond to the cluster management unit 130 in FIG. 1 and the cluster management unit 130a in FIG. 2. The namespace management unit may correspond to the namespace management unit 150 in FIG. 1 and the namespace management unit 150a in FIG. 2.

In an embodiment, the storage unit 810 may include USERIF storage 811, CLDIF storage 812, CLTIF storage 813, CLIIF storage 814, NSTIF storage 815, and NSIIF storage 816.

In an embodiment, the storage unit 810 may store information generated in a container orchestration system (e.g., 1000 in FIG. 1 or 1000a in FIG. 2).

In an embodiment, the storage unit 810 may store user information in the USERIF storage 811. For example, the user information may include information such as the ID, password, user name, address, and affiliation user group of a user using a cloud server.

In an embodiment, the storage unit 810 may store cloud information in the CLDIF storage 812. For example, the cloud information may include information such as communication status with a cloud server, cloud server access API, cloud server authentication account, virtual machine OS image name, SSH information, and the like.

In an embodiment, the storage unit 810 may store cluster template information in the CLTIF storage 813. For example, the cluster template information may include items illustrated in FIG. 3, and may further include information such as cluster template ID, user name, maximum number of servers, maximum usage period, and the like.

In an embodiment, the storage unit 810 may store cluster instance information in the CLIIF storage 814. For example, the cluster instance information may include items illustrated in FIG. 5, and may further include information such as cluster instance ID, user name, affiliation user group, operation status of virtual machine instances, number of virtual machine instances, usage end date, and the like.

In an embodiment, the storage unit 810 may store namespace template information in the NSTIF storage 815. For example, the namespace template information may include the items illustrated in FIG. 10, and may further include information such as namespace template ID, user name, maximum usage period, and the like.

In an embodiment, the storage unit 810 may store namespace instance information in the NSIIF storage 816. For example, the namespace instance information may include items illustrated in FIG. 12, and may further include information such as namespace instance ID, user name, cluster instance ID where the namespace instance is generated, operation status of namespace instances, end-of-use date, and the like.

In an embodiment, the cloud management unit 820 may include a CLD communicator 821, a CLD monitor 822, an FLV generator 823, a VMI generator 824, and a VMI deleter 825.

In an embodiment, the CLD communicator 821 may perform communication with a cloud server of the container orchestration device 800. For example, the CLD communicator 821 may perform communication with the cloud server based on a cloud access API, a cloud authentication account, and the like.

In an embodiment, the CLD monitor 822 may periodically monitor the cloud server. For example, the CLD monitor 822 may monitor the status of communication with the cloud server and the status of virtual machine instances provided from the cloud server, and store them in the storage unit 810 based on the monitoring results.

In an embodiment, the FLV generator 823 may generate a plurality of flavors within the cloud server. For example, the flavor may be a system resource required for the cloud server to generate a plurality of virtual machine instances.

In an embodiment, the VMI generator 824 may generate a virtual machine within the cloud server, and the VMI deleter 825 may delete a virtual machine within the cloud server.

In an embodiment, the user management unit 830 may include a USER adder 831 and a USER deleter 832.

In an embodiment, the USER adder 831 may add a user to an arbitrary user group. For example, the USER adder 831 may add a user based on information such as ID, user name, email address, and affiliated user group of the user to be added, and may store the information in the storage unit 810.

In an embodiment, the USER deleter 832 may delete users from an arbitrary user group. For example, the USER deleter 832 may delete a user based on the ID of the user to be deleted, and delete information about the user to be deleted from the storage unit 810.

In an embodiment, the user interface unit 840 may receive request signals from a user or a user group including the user, and control the container orchestration device 800 based on the request signals.

In an embodiment, the cluster management unit 850 may include a cluster template management unit 851 and a cluster instance management unit 855.

In an embodiment, the cluster template management unit 851 may include a CLT generator 852, a CLT modifier 853, and a CLT deleter 854. For example, the CLT generator 852 may generate cluster template information in the CLTIF storage 813. The CLT modifier 853 may modify the cluster template information and store it in the CLTIF storage 813. In addition, the CLT deleter 854 may delete the cluster template information from the CLTIF storage 813.

In an embodiment, the cluster instance management unit 855 may include a CLI generator 856, a CLI modifier 857, a CLI deleter 858, and a CLI monitor 859. For example, the CLI generator 856 may generate cluster instance information in the CLIIF storage 814. The CLI modifier 857 may modify the cluster instance information and store it in the CLIIF storage 814. In addition, the CLI deleter 858 may delete the cluster instance information from the CLIIF storage 814.

In an embodiment, the namespace management unit 860 may include a namespace template management unit 861 and a namespace instance management unit 865.

In an embodiment, the namespace template management unit 861 may include an NST generator 862, an NST modifier 863, and an NST deleter 864. For example, the NST generator 862 may generate the namespace template information in the NSTIF storage 815. The NST modifier 863 may modify the namespace template information and store it in the NSTIF storage 815. In addition, the NST deleter 864 may delete the namespace template information from the NSTIF storage 815.

In an embodiment, the namespace instance management unit 865 may include an NSI generator 866, an NSI modifier 867, an NSI deleter 868, and an NSI monitor 869. For example, the NSI generator 866 may generate namespace instance information in the NSIIF 816. The NSI modifier 867 may modify the namespace instance information and store it in the NSIIF storage 816. In addition, the NSI deleter 868 may delete the namespace instance information from the NSIIF storage 816.

As described above, the container orchestration device according to the embodiments of the present disclosure may generate a container orchestration tool within a cloud server based on a user request signal and may allocate the container orchestration tool to a user group. The container orchestration device may generate one or more namespace instances within the container orchestration tool and may individually allocate the one or more namespace instances to each user of a user group. According to the container orchestration device, a user group using cloud computing may efficiently manage virtualized computing resources within the cloud, and the user group (or each user of the user group) may freely run and deploy containers by using the allocated orchestration tool and allocated namespace instances.

At least one of the units, components, elements, modules, or the like (collectively “units” in this paragraph) represented by a block or an equivalent indication (collectively “block”) in the above embodiments including the drawings may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories to perform the respective functions or operations described above.

Specific embodiments have been described above. The present disclosure may include not only the above-described embodiments, but also simple design changes or easily changeable embodiments. In addition, the present disclosure may include techniques that can easily modify and implement the embodiments. Therefore, the scope of the present disclosure should not be limited to the above-described embodiments, but should be defined by the claims described below as well as the claims and equivalents.

What is claimed is:

1. A container orchestration device comprising:
a cloud management unit configured to communicate with a cloud server based on user request signals;
a cluster management unit configured to generate a container orchestration tool within the cloud server based on a first request signal among the user request signals and allocate the container orchestration tool to a first user group; and
a namespace management unit configured to generate one or more namespace instances within the container orchestration tool based on the first request signal and allocate the one or more namespace instances to each user of the first user group.

2. The container orchestration device of claim 1, further comprising:
a storage unit configured to store a plurality of cluster template information, each of the plurality of cluster template information including system resources of a plurality of flavors;
wherein the cluster management unit is configured to:
generate the plurality of cluster template information based on the first request signal and store the plurality of cluster template information in the storage unit; and
generate the plurality of flavors on the cloud server.

3. The container orchestration device of claim 2, wherein the cluster management unit is configured to:
generate cluster instance information based on the first request signal and the plurality of cluster template information; and
store the cluster instance information in the storage unit.

4. The container orchestration device of claim 3, wherein the cluster management unit is configured to:
generate a plurality of virtual machine instances in the cloud server based on the cluster instance information; and
set up the container orchestration tool based on the plurality of virtual machine instances.

5. The container orchestration device of claim 4, wherein the cluster management unit is configured to:
periodically monitor the plurality of virtual machine instances constituting the container orchestration tool based on the cluster instance information; and
update the storage unit based on a result of monitoring the plurality of virtual machine instances.

6. The container orchestration device of claim 4, wherein the cluster management unit is configured to:
delete the cluster instance information from the storage unit based on the first request signal.

7. The container orchestration device of claim 4, wherein the storage unit is configured to further store a plurality of namespace template information, each of the plurality of namespace template information including namespace storage resources, and
the namespace management unit is configured to generate the plurality of namespace template information based on the first request signal and store the plurality of namespace template information in the storage unit.

8. The container orchestration device of claim 7, wherein the namespace management unit is configured to:
generate namespace instance information based on the first request signal and the plurality of namespace template information; and
store the namespace instance information in the storage unit.

9. The container orchestration device of claim 8, wherein the namespace management unit is configured to update the container orchestration tool based on the namespace instance information.

10. The container orchestration device of claim 9, wherein the namespace management unit is configured to:
periodically monitor the one or more namespace instances included in the container orchestration tool based on the namespace instance information; and
update the storage unit based on a result of monitoring the one or more namespace instances.

11. The container orchestration device of claim 9, wherein the namespace management unit is configured to delete the namespace instance information from the storage unit based on the first request signal.

12. The container orchestration device of claim 1, wherein the first user group includes a plurality of first users, and
the namespace management unit is configured to individually allocate all or some of the one or more namespace instances to each of the plurality of first users.

13. A container orchestration device comprising:
a cloud management unit configured to communicate with a cloud server based on user request signals;
a cluster management unit configured to generate a first container orchestration tool within the cloud server based on a first request signal among the user request signals, allocate the first container orchestration tool to a first user group, generate a second container orchestration tool within the cloud server based on a second request signal among the user request signals, and allocate the second container orchestration tool to a second user group; and
a namespace management unit configured to generate one or more first namespace instances within the first container orchestration tool based on the first request signal, allocate the one or more first namespace instances to each user of the first user group, generate one or more second namespace instances within the second container orchestration tool based on the second request signal, and allocate the one or more second namespace instances to each user of the second user group.

14. The container orchestration device of claim 13, further comprising:
a storage unit configured to store a plurality of cluster template information, each of the plurality of cluster template information including system resources of a plurality of flavors,
wherein the cluster management unit is configured to:
generate a plurality of first cluster template information based on the first request signal and store the plurality of first cluster template information in the storage unit;
generate a plurality of second cluster template information based on the second request signal and store the plurality of second cluster template information in the storage unit; and
generate the plurality of flavors on the cloud server.

15. The container orchestration device of claim 14, wherein the cluster management unit is configured to:
generate first cluster instance information based on the first request signal and the plurality of first cluster template information;
generate second cluster instance information based on the second request signal and the plurality of second cluster template information; and
store the first cluster instance information and the second cluster instance information in the storage unit.

16. The container orchestration device of claim 15, wherein the cluster management unit is configured to:
generate a plurality of first virtual machine instances in the cloud server based on the first cluster instance information;
set up the first container orchestration tool based on the plurality of first virtual machine instances;
generate a plurality of second virtual machine instances in the cloud server based on the second cluster instance information; and
set up the second container orchestration tool based on the plurality of second virtual machine instances.

17. The container orchestration device of claim 16, wherein the storage unit is configured to further store a plurality of namespace template information, each of the plurality of namespace template information including namespace storage resources, and
the namespace management unit is configured to:
generate a plurality of first namespace template information based on the first request signal and store the plurality of first namespace template information in the storage unit; and
generate a plurality of second namespace template information based on the second request signal and store the plurality of second namespace template information in the storage unit.

18. The container orchestration device of claim 17, wherein the namespace management unit is configured to:
generate first namespace instance information based on the first request signal and the plurality of first namespace template information;
generate second namespace instance information based on the second request signal and the plurality of second namespace template information; and
store the first namespace instance information and the second namespace instance information in the storage unit.

19. The container orchestration device of claim 18, wherein the namespace management unit is configured to:
update the first container orchestration tool based on the first namespace instance information; and
update the second container orchestration tool based on the second namespace instance information.

20. The container orchestration device of claim 13, wherein the first user group includes a plurality of first users,
the second user group includes a plurality of second users, and
the namespace management unit is configured to:
individually allocate all or some of the one or more first namespace instances to each of the plurality of first users; and
individually allocate all or some of the one or more second namespace instances to each of the plurality of second users.
